(19) United States
(12) Patent Application Publication
(10) Pub. No.: US 2007/0150702 A1
(43) Pub. Date: Jun. 28, 2007

(54) Processor

(76) Inventors: Henry T. Verheyen, San Jose, CA (US); Raj Kumar Mathur, Fremont, CA (US); William Watt, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/318,042

(22) Filed: Dec. 23, 2005

(51) Int. Cl. G06F 15/00

(52) U.S. Cl. 712/34

(57) ABSTRACT

A processor system comprising a processor and a memory system with a high data transfer rate and low average power consumption of related I/O activity. The processor system may be disposed on a single circuit board. One embodiment of a disclosed system includes a processor system that comprises a processor device, a memory device and a circuit board. The circuit board includes a substrate, electrical contacts, and interconnection lines between the contacts. The electrical contacts of the circuit board may be coupled to electrical contacts on the processor device and the memory device. The interconnection lines communicate signals, such as data or instructions, between the electrical contacts of the memory device and the process device at least 200 billion bits per second while related input/output activity of the processor and the memory consumes an average power less than ten watts.

### BACKGROUND OF THE INVENTION

1. Field of the Invention

The present invention generally relates to the field of processors, and more specifically, to processors that provide high data rate transfers with memories.

1. Description of the Related Art

Simulation of a logic design and other computer applications typically process large amounts of data at high speed. As semiconductor devices get smaller, pin count limits the number of signal lines. Faster data rates of input/output (I/O) increases power dissipation of the devices.

From the above, there is a need for a system and process for high performance processing, and may include high data rate transfer between a processor and memory and low power dissipation.

### SUMMARY OF THE INVENTION

The present invention provides a processor system comprising a processor and a memory system with a high data transfer rate and low average power consumption of related I/O activity. The processor system may be disposed on a single circuit board. One embodiment of a disclosed system includes a processor system that comprises a processor device, a memory device and a circuit board. The circuit board includes a substrate, electrical contacts, and interconnection lines between the contacts. The electrical contacts of the circuit board may be coupled to electrical contacts on the processor device and the memory device. The interconnection lines communicate signals, such as data or instructions, between the electrical contacts of the memory device and the electrical contacts of the processor device at least 200 billion bits per second while related input/output activity of the processor to the memory consumes an average power less than five Watts and related input/output activity of the memory to the processor consumes an average power less than five Watts.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 illustrates a first embodiment of a processor system.

FIG. 2 illustrates a second embodiment of a processor system.

FIG. 3 illustrates a third embodiment of a processor system with a main processor and a separate co-processor.

FIG. 4 illustrates a fourth embodiment of a processor system and including a processor and a co-processor.

FIG. 5 illustrates a fifth embodiment of a processor system including a processor module, a co-processor module and a high data rate channel.

FIG. 6 illustrates a sixth embodiment of a processor system including a processor module and a co-processor module.

FIG. 7 illustrates a seventh embodiment of a processor system including a processor module and a memory module.

FIG. 8 illustrates an eighth embodiment of a processor system including processor modules and a memory module.

FIG. 9 illustrates a ninth embodiment of a processor system including a processor module and a memory module.

FIG. 10 illustrates a tenth embodiment of a processor system including a processor module and a plurality of memory modules.

FIG. 11 illustrates an eleventh embodiment of a processor system including a processor module and a plurality of modules with feedback.

FIG. 12 is a top plan view of a first embodiment of a circuit card of the processor system of FIG. 3.

FIG. 13 is a bottom plan view of the circuit card of FIG. 12.

FIG. 14 is a side view of a second embodiment of a circuit card of the processor system of FIG. 3.

FIG. 15 is a top plan view of the circuit card of FIG. 14.

FIG. 16 is a bottom plan view of the circuit card of FIG. 14.

FIG. 17 is a cross-sectional view of a third embodiment of a circuit card of the processor system of FIG. 3.

FIG. 18 is a top plan view of a portion of the circuit card of FIG. 17.

FIG. 19 is a top plan view of a portion of the circuit card of FIG. 17 and including blind vias.

FIG. 20 is a top plan view of a portion of the circuit card of FIG. 17 and including blind vias and dashed lines indicating circuit traces on a bottom surface of the circuit card of FIG. 17.

FIG. 21 is a bottom plan view of a portion of the circuit card of FIG. 17 including circuit traces and locations of termination resistor on a bottom surface of the circuit card of FIG. 17.

FIG. 22 is a top plan view of a voltage layer of the circuit card of FIG. 17 including blind top layer vias and through vias.

FIG. 23 is a top plan view of a voltage layer of the circuit card of FIG. 17 including blind top layer vias, through vias, and blind bottom layer vias.

FIG. 24 illustrates bottom and top perspective views and a side view of one embodiment of the circuit board of FIG. 14.

FIG. 25 illustrates bottom and top perspective views and a side view of another embodiment of the circuit board of FIG. 14.

FIG. 26 is an exploded view of another embodiment of the circuit board of FIG. 14.

FIG. 27 is a perspective view of a multi-laminate circuit board of the processor system of FIG. 3.

FIG. 28 is a perspective view of a first embodiment of an adaptor board of the processor system of FIG. 1.

FIG. 29 is a perspective view of a second embodiment of an adaptor board of the processor system of FIG. 1.

### DETAILED DESCRIPTION OF THE PREFERRED EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a processor system including a processor and a memory system that communicate at high data rates with low I/O power consumption and disposed on a single circuit board or disposed to fit in standardized physical dimensions.

Architectural Overview

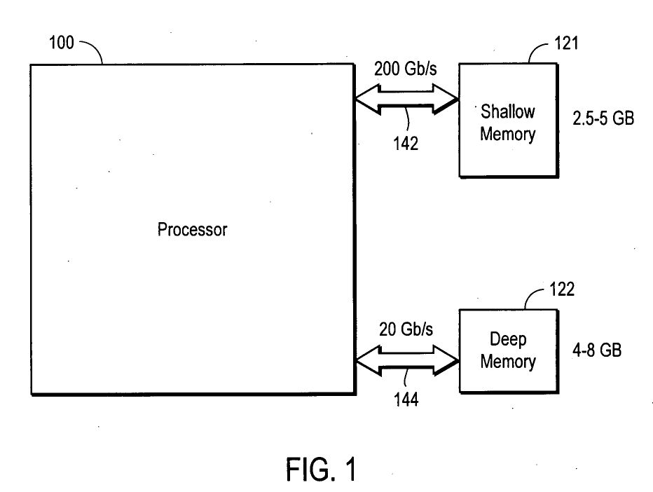

FIG. 1 illustrates a first embodiment of a processor system. The processor system includes a processor 100, a program memory 121, a storage memory 122 and communication channels 142 and 144. For more details on the communication channels 142 and 144 and the memory organization, see for example U.S. patent application Ser. No. 11/292,712 entitled “Hardware Acceleration System for Simulation of Logic and Memory,” filed Dec. 1, 2005 by Verheyen and Watt, the contents of which are incorporated herein by reference.

In an illustrative embodiment, the channel 142 communicates at a rate of at least 200 gigabits per second, and the channel 144 communicates at a rate of at least 20 gigabits per second. In this first embodiment, the program memory 121 stores 2.5 to 5 gigabytes, and the storage memory 122 stores 4 to 8 gigabytes. In another embodiment, the program memory 121 stores data, and the storage memory 122 stores instructions. The program memory 121 also may store data, and the storage memory 122 also may store instructions.

The program memory 121 and the storage memory 122 are distinct in that they can be viewed as wide and shallow versus narrow and deep. As explained in U.S. patent application Ser. No. 11/292,712, the program memory 121 is accessed via a wider port whereas the storage memory 122 is accessed via a narrower port. If the two memories are similar in size, wider port access results in a lesser address depth (shallow) versus the narrower port access, which yields a deeper address depth (deep). We therefore refer to the two memories as “wide and shallow” and “narrow and deep”.

In one embodiment, the program memory 121 is realized as a reg [2,560] mem [8M], e.g., 8 million words of 2,560 bits each, whereas the storage memory 122 is physically realized as a reg [256] mem [125M], further divided by hardware and software logic into a reg [64] mem [500M], e.g., 500 million words of 64 bits each. Relatively speaking, the program memory 121 is wide (2,560 bits per word) and shallow (8 million words), whereas the storage memory 122 is narrow (64 bits per word) and deep (500 million words).

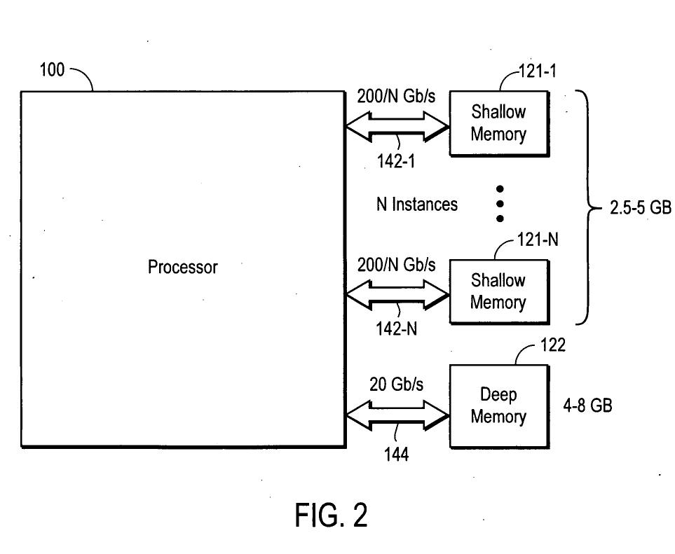

FIG. 2 illustrates a second embodiment of a processor system. The processor system of FIG. 2 is similar to the processor system of FIG. 1, but the program memory 121 is partitioned into a plurality of memories 121-1 through 121-N, and the communication channel 142 is partitioned into a plurality of communication channels 142-1 through 142-N. Each memory 121-1 through 121-N may be equal in size and have similar architecture. In this instance, each memory 121-1 through 121-N communicates with the processor 100 at a rate 1/N of the overall rate, or in the illustrative embodiment 200/N gigabits per second.

In one embodiment, N=10. Then the memory bandwidth on each interfaces 142-1 through 142-N for each of the shallow memories 121-1 through 121-N is equal to that of interface 144 of the deep memory 122. Or, in the architecture, memory 121 reg [2,560] mem [8M] would comprise 10 parallel instances of a reg [256] mem [8M]. This is compared with memory 122 which is physically realized as a reg [256] mem [125M]. This illustrates that the memory 122 is much deeper (over 10 times) than each memory instance 121-1 through 121-N, but the N instances of memory 121-1 through 121-N yield a much wider (10 times wider) port, collectively, than memory 122.

Electrically, each interface 142-1 through 142-N to each memory instance 121-1 through 121-N may be realized similarly as the interface 144 to memory 122. Because of the larger depth of memory 122, additional address lines are used, and to realize the larger depth, more physical area is used. Even though conceptually the memory 122 architecture can be utilized to realize each of the memory instances 121-1 through 121-N, it is more efficient in practice to optimize them separately.

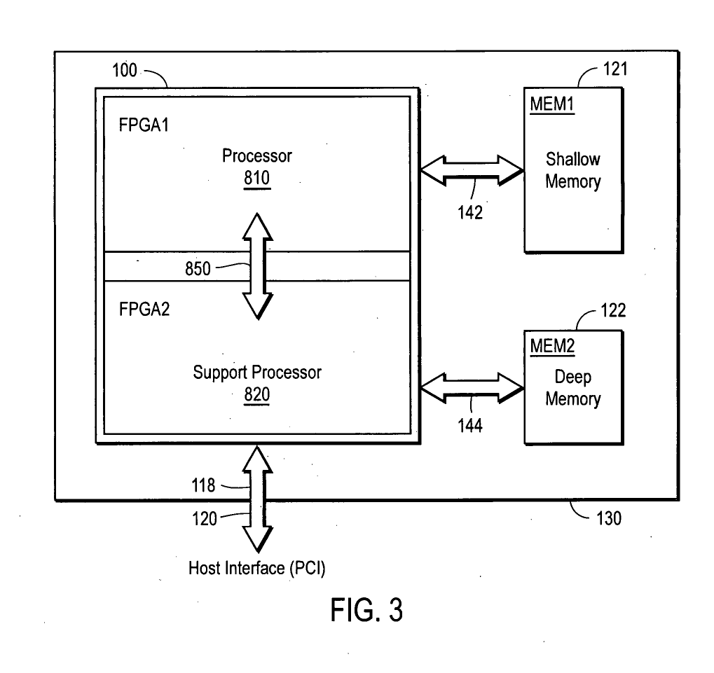

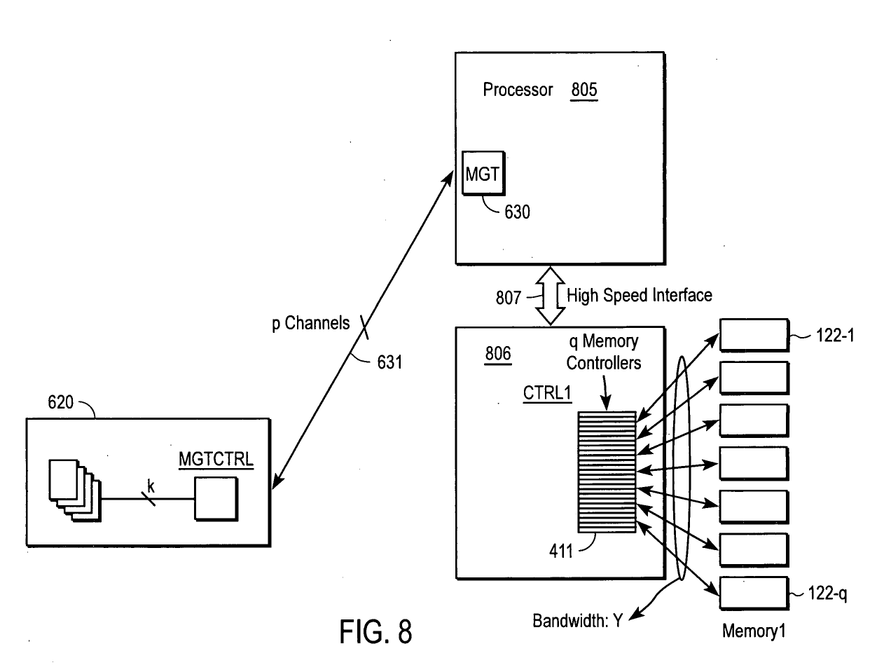

FIG. 3 illustrates a third embodiment of a processor system with a main processor and a separate co-processor. The processor 100 comprises a processor 810 and a support processor 820, coupled by a communication channel 850 between the processor 810 and the processor 820. The processor 100 and the memories 121 and 122 are disposed on a circuit board 130. A communication channel 118 couples the support processor 820 to an external communication channel 120. The communication channels 118 and 120 may comply with a standard, such as a PCI standard. Please note that the numbering of the processor system of FIG. 3 follows the numbering of both FIG. 1 and FIG. 8 of the above referenced U.S. patent application Ser. No. 11/292,712, which describes this configuration in detail.

In one embodiment, the processor system may be a hardware accelerator for performing logic simulation of a logic design. The processor 100 is a simulation processor, and the processor 810 and the support processor 820 are each configurable to simulate a logic function. The memories 121 and 122 function as program memory communicatively coupled to the simulation processor 100 for storing instructions for the processors 810 and 820. In another embodiment, the memories 121 and 122 are external to the processor 100. Instructions are transferable from the program memory 121 to the simulation processor 100 at an average rate of at least 200 billion bits per second while related input/output activity of the simulation processor 100 to the program memory 121 consumes an average power less than five Watts and related input/output activity of the program memory 121 to the simulation process consumes an average power less than five Watts.

In various embodiments, the processor system consumes total average power less than 50 Watts. The program memory 121 has capacity to store instructions having at least 20 billion bits. In another embodiment, the program memory 121 has capacity to store data having at least 20 billion bits.

In a serial interface implementation, the input/output interface of the processor 100 and the memories 121 and 122 may consume no standby current, but may communicate signals at data transport rates of at least 300 MHz. The processor 100 and the memories 121 and 122 may communicate data at a rate of at least 200 billion bits of data per second while the input/output interfaces consume an average power less than five Watts during said data transport from the processor 100 to the memories 121 and 122 and the input/output interfaces consume an average power less than five Watts during data transport from the memories 121 and 122 to the processor 100.

In one embodiment, the memories 121 or 122 may be subdivided into at least two different groups. Each group may include one or more memory components or devices, and may include separate direct memory access (DMA) from a host computer (not shown). One memory group may be used for instructions and another memory group may be used for data. The processor system may allow parallel update for the memory groups during which the memory group used for data memory (e.g., from the host computer using DMA) while the processor system processes data using the memory group normally used for instructions. In an illustrative embodiment, each memory group has a capacity of at least 2 Gigabytes.

With today's high data-rates, significant progress has been made with double (DDR) and quadruple data-rate memories (QDR). Memory systems that include large amounts of such memories, e.g., PC motherboards, produce additional heat due to the memory interfaces operating at high speeds. Architectures such as the described processor system, which includes a very wide data-path into memory, tend to produce higher amounts of heat and all single system embodiments that have been realized with the memory interface bandwidth being above 200 billion bits per second to date do so while consuming excessive power, which produces heat and they use dedicated active cooling solutions to dissipate the additional heat generated by the memory interfaces. Two specific approaches are described; both deliver the memory interface bandwidth above 200 billion bits per second while consuming significantly less power, which produces less heat and therefore do not use dedicated active cooling solutions. In the first approach, passive termination and a very high interface pin-count are used in the processor 100; in the second approach, high-speed interfacing techniques are used that enable distributing the high memory interface pin-count and interface power away from the processor 100. The second approach uses more volume and more total power than the first approach. The two approaches can be combined.

In one embodiment, used in the first approach, the processor system may be a hardware accelerator for executing very long instruction words of a logic design. The processor 100 is a very long instruction word (VLIW) processor and the processors 810 and 820 are configurable to simulate a logic function. The processor 100 includes at least 500 interface pins.

The program memory 121 and 122 are external to the processor 100 and stores instructions for the processors 810 and 820. Instructions are transferable from the program memory 121 to the processor 100 at an average rate of at least 200 billion bits per second while related input/output activity of the VLIW processor 100 to the program memory 121 consumes an average power less than five Watts and related input/output activity of the program memory 121 to the VLIW processor 100 consumes an average power less than five Watts.

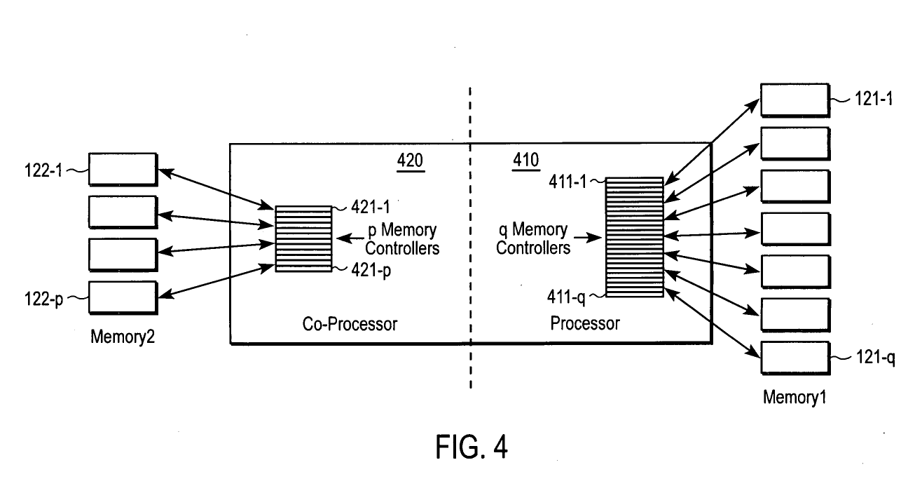

FIG. 4 illustrates a fourth embodiment of a processor system. The processor system comprises a processor 100 that includes a processor 410 and a co-processor 420. The processor 410 comprises a plurality of memory controllers 411-1 through 411-q coupled to a corresponding memory 121-1 through 121-q. The co-processor 420 comprises a plurality of memory controllers 421-1 through 421-p coupled to a corresponding memory 122-1 through 122-p.

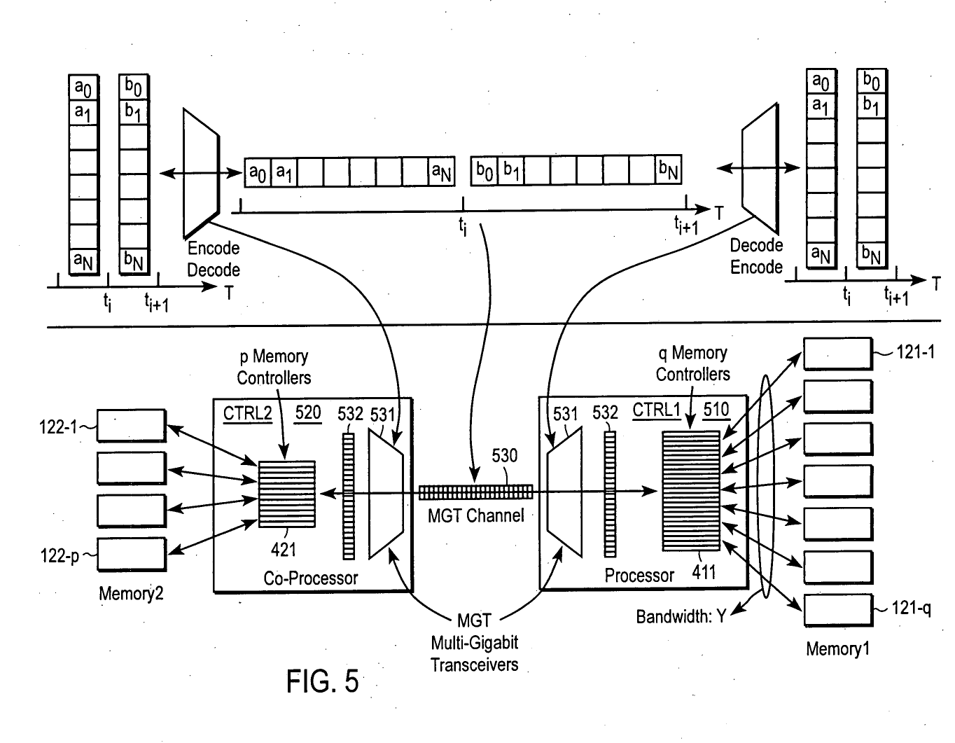

FIG. 5 illustrates a fifth embodiment of a processor system. The processor system in FIG. 5 includes separate processors with a high serial data rate channel between the processors. The processor of FIG. 5 is similar to the processor system in FIG. 4 but includes a processor 510 and a co-processor 520, and a communication channel 530 coupled between the processors 510 and 520. The communication channel 530 may be one or more multi-gigabit transceiver (MGT) channels. The processor 510 comprises a multi-gigabit transceiver 531 and a data buffer 532 coupled between the MGT transceiver 531 and the plurality of memory controllers 411. The processor 520 comprises a MGT transceiver 531 and a data buffer 532 coupled between the MGT transceiver 531 and the plurality of memory controllers 421. The upper portion of FIG. 5 shows the encoding, transmission, and decoding of data. Data bits are stored in parallel in the data buffer 532. As an illustrative example during a time interval ti, an N bit data field (a0, . . . , aN) is stored in parallel in the data buffer 532 and converted into a serial data stream by the MGT transceiver 531 at a higher data rate to allow serial transmission of the N bits during a time period ti, which is at a data rate greater or equal to the data frequency (Df) times the number of bits N. Likewise during a second time interval ti+1, a number N data bits (b0, . . . , bN) are decoded into a serial data transmission during a time ti+1. The MGT transceiver 531 in the other processor converts the serial data into parallel data for storage in the corresponding data buffer 532.

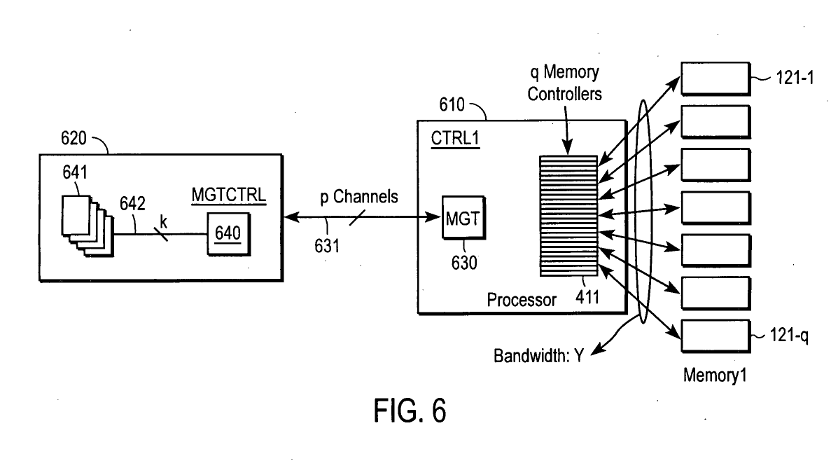

FIG. 6 illustrates a sixth embodiment of a processor system including a processor module and a co-processor module. In FIG. 6, the co-processor 520 and the processor 510 (see FIG. 5) are structured as a single processor 610 which helps simplify the diagrams. When using MGTs, this partitioning is feasible in the processor systems of the present invention. Inside the MGT controller (MGTCTRL) 620, element 640 represents the p memory controllers 421-1 through 421-p that were inside co-processor 520. The memory 122 is now represented as memory 641 and the memory interface channels are shown as channels 642, having a width k. For simplicity it is assumed that each of the p memory controllers 421-1 through 421-p is mapped to a dedicated MGT channel 642 inside the MGT controller 620. Therefore, the communication channel 631 comprises p channels, one for each of the p memory controllers 421. Note that this is not a requirement, but it simplifies the explanation. The MGT interface 630 now represents a direct mapping of the p memory channels to the processor 610.

The processor 510 may be replaced by MGT channels in a very similar fashion. The MGTCTRL controller module 620 is used to realize the q memory controllers 411-1 through 411-q. Note that using MGTCTRL controller module 630 converts the shallow memory 122 into deep memory as well. This feature maybe used to increase memory capacity for the memory 122 and thus enhance the system capacity in the processor systems.

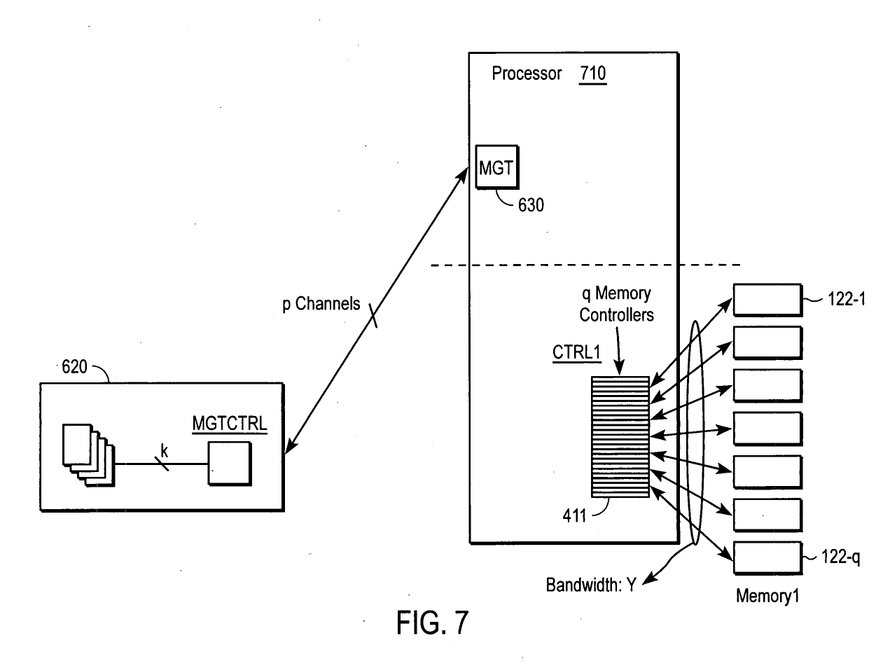

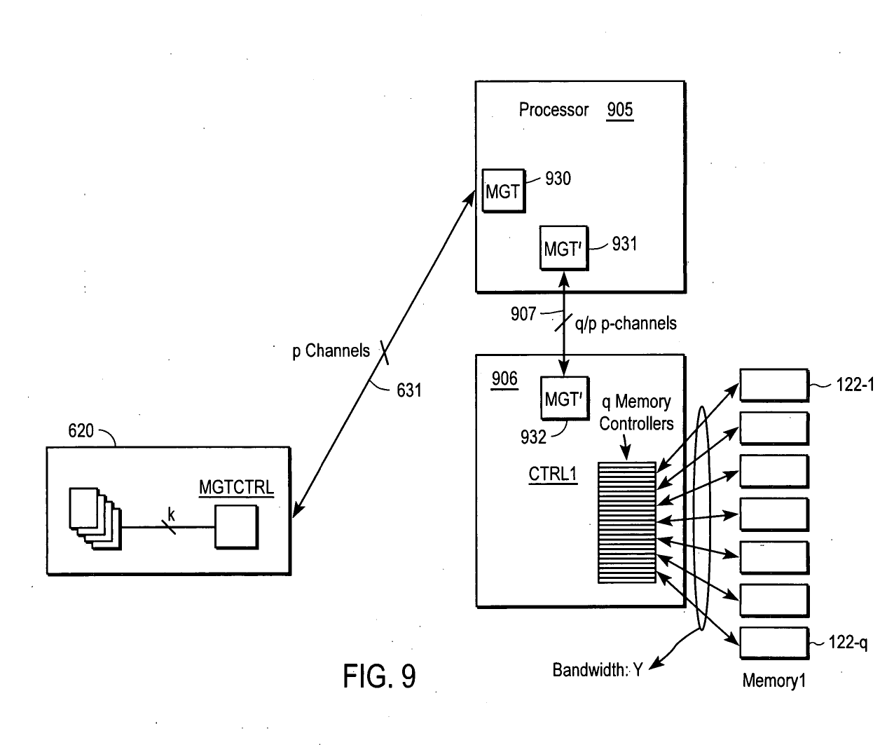

Referring to FIG. 7, the processor 610 is drawn in a similar fashion as in FIG. 4, and FIGS. 8 and 9 which are analogous to FIGS. 5 and 6.

FIG. 7 illustrates the seventh embodiment of a processor system. A processor system of FIG. 7 is similar to the processor system of FIG. 6, but includes a processor 710 that is similar to the processor 610 and further comprises a MGT system 630 disposed in a device separate from the memory controllers 411 as indicated by the dotted lines.

FIG. 8 illustrates an eighth embodiment of the processor system. The processor system of FIG. 8 is similar to the processor system of FIG. 7, but replaces the processor 710 with processors 805 and 806 coupled together by a high speed channel 807. The processor 805 includes the MGT system 630. The processor 806 includes a plurality of memory controllers 411. This embodiment separates portions of the processor between two devices and communicates data over the high speed interface 807.

FIG. 9 illustrates a ninth embodiment of a processor system. The processor system in FIG. 9 is similar to the processor in FIG. 8, but includes processors 905 and 906 instead of processors 805 and 806, respectively. The processor 905 includes an MGT processor 931 for communicating on a channel 907. The processor 906 includes an MGT processor 932 for communicating on the channel 907, which includes a number q/p p-channels. The system of FIG. 9 replaces the high speed channel 807 of FIG. 8 with a plurality of parallel channels.

In FIG. 9, the channel MGT 930 represents p MGT channels that communicate to the p controllers 421-1 through 421-p. The channel MGT′ 931 represents q channels that communicate to q controllers 411-1 through 411-q. Because the MGTCTRL 620 is reused to also embody the q controllers 411-1 through 411-q, q/p instances of MGTCTRL 620 are used. Therefore, the channel MGT′ 931 can be realized as q/p instances of MGT 930, each of which has p channels. The interface 907 is thus realized as q/p p-channels.

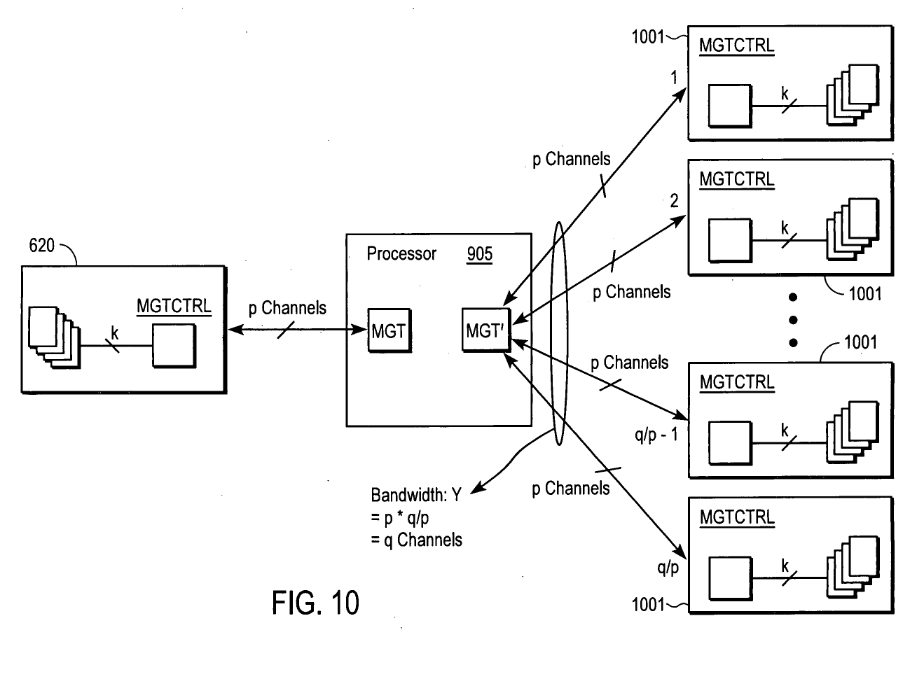

FIG. 10 illustrates a tenth embodiment of a processor system. The processor system in FIG. 10 is similar to the processor system of FIG. 9, but the processor 906 and the memory 122 are replaced by a plurality of MGT controller modules 1001. The MGT controller module 1001 is similar to the module 620. In an illustrative embodiment, the processor system includes q/p controller modules 1001 with each module 1001 including p channels.

In one realization, the p-memory controllers 421-1 through 421-p in FIG. 5 have been realized with p=2, resulting in a bandwidth of over 50 Giga bits per second. Thus the MGTCTRL controller module 620 can be viewed as a more than 50 Giga bits per second interface, comprising 2 channels (p=2). To realize a bandwidth Y of more than 200 Giga bits per second, the processor system includes at least 4 instances of the MGTCTRL controller 620 (q/p=4). It follows therefore that q=8. The processor 905 can be viewed as having 2 (p=2) memory controllers for the memory 122 and 8 (q=8) memory controllers for the memory 121. Because the MGTCTRL controller modules 1001 do not require the same depth as the MGTCTRL controller module 630, further optimization is possible by reducing the address depth and thus saving physical area.

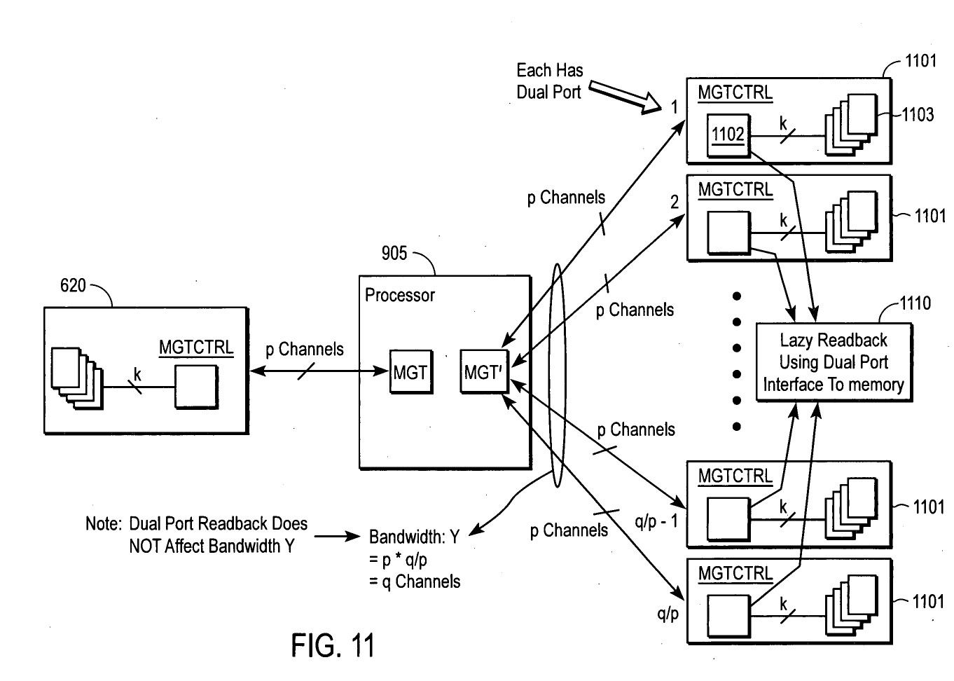

FIG. 11 illustrates an eleventh embodiment of a processor system. The processor system of FIG. 11 is similar to the processor system in FIG. 10, but further comprises a MGT controller module 1101 that includes a MGT controller 1102 and a plurality of memories 1103, and also comprises a feedback system 1110 to provide a read back using a dual port interface to memory. One embodiment of the read back using a dual port interface to memory is described in U.S. patent application Ser. No. 11/296,007, “PARTITIONING OF ASKS FOR EXECUTION BY A VLIW HARDWARE ACCELERATION SYSTEM,” filed Dec. 6, 2005 by Verheyen and Watt, which is incorporated herein by reference. When VCD (Value Change Dump, e.g., debug data) data is written back to the memory 121, it is written back multiple times. Rather than reducing the physical area of the MGTCTRL controller module 1101, the MGT controller 1102 includes an interface to support dual controller interfacing. The MGT controller includes two controllers, with a second controller having access to additional memory instances, but not used to map memory 121 (shown as memory 1103 in FIG. 11). When the MGTLCTRL controller module 1001 receives a VCD data write request, it stores the data inside memory instances used to map memory 121, and, using the secondary memory controller of MGT controller 1102, the write data also is copied into the additional memory instances, not used to map memory 121, creating a shadow memory. This second controller does not affect the main bandwidth Y to memory 121, only the write data is copied from the first controller to the second controller. Reading back from the shadow memory goes through the second controller and can be done during read cycles in the first controller. This way we can read the VCD data back to the host computer, without consuming any of the bandwidth Y to memory 121. Rather we have created additional memory bandwidth that accesses the shadow memory instances only, using the secondary memory controller inside the MGTCTRL controller modules 1101.

Physical Implementation

Various embodiments for the physical implementation of the processor systems of FIG. 1 are next described.

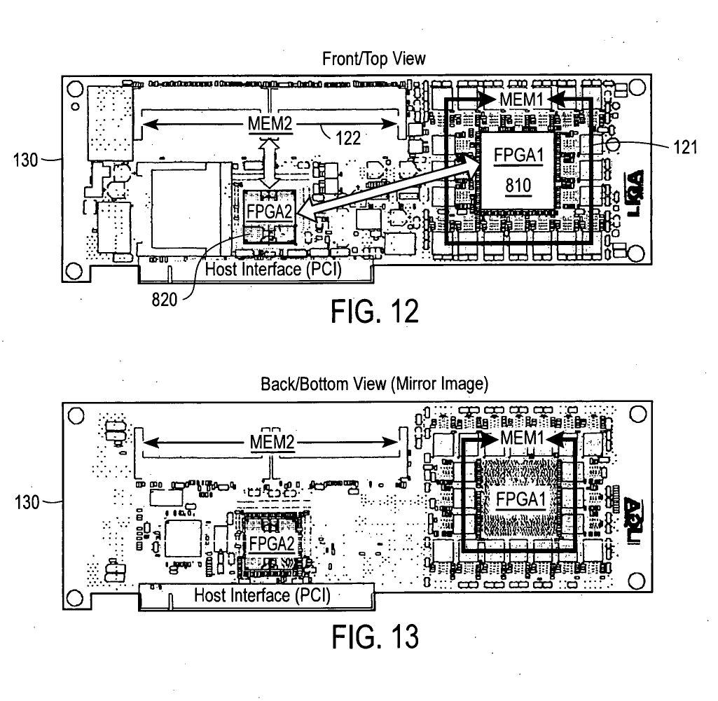

FIG. 12 is a top plan view of a first embodiment of a circuit card of the processor system of FIG. 3. FIG. 13 is a bottom plan view of the circuit card of FIG. 12. The circuit card 130 may comply with a standard interfacing specification, such as a PCI standard. The circuit card 130 may comply with a mechanical chassis standard which restricts power consumption and heat generation, a standard mechanical interfacing specification, or physical dimensions of a standard such as a PCI standard. The interface standard may allow direct memory access (DMA) to the memory system 121 and 122 from a host computer. In an illustrative embodiment, the processor system of FIG. 3 including a circuit board of FIG. 12 may include a processor 810 formed of a field programmable gate array (FPGA) model XC4VLX160-10FF1513C and the processor 820 formed of an FPGA model XC4VLX40-10FF668C, both manufactured by Xilinx. The memory 121 may be formed out of individual memory ICs of model MT46H32M16LFCK-6, manufactured by Micron Technology Inc., and the memory 122 may be formed out of SODIMM modules model KVR533D2S4/1G, manufactured by Kingston Technology.

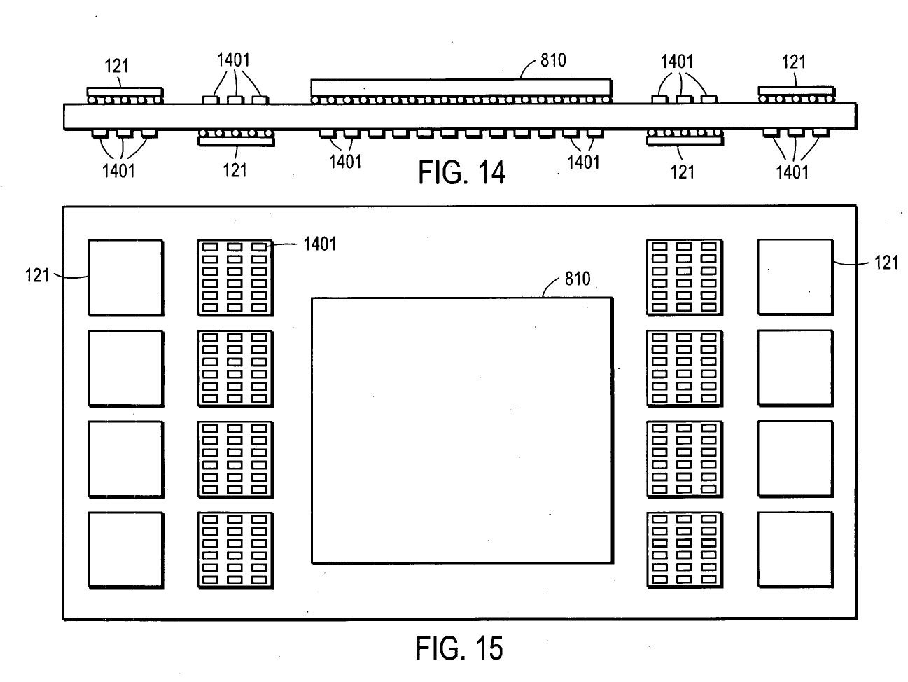

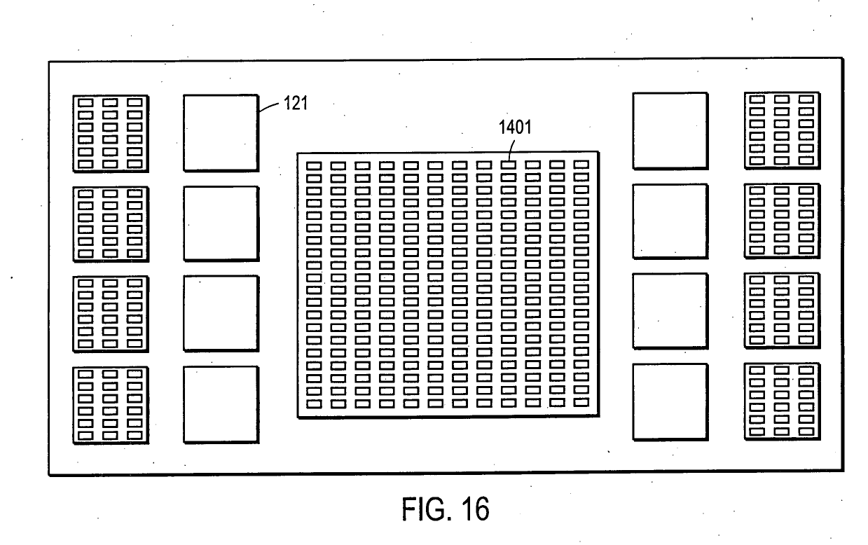

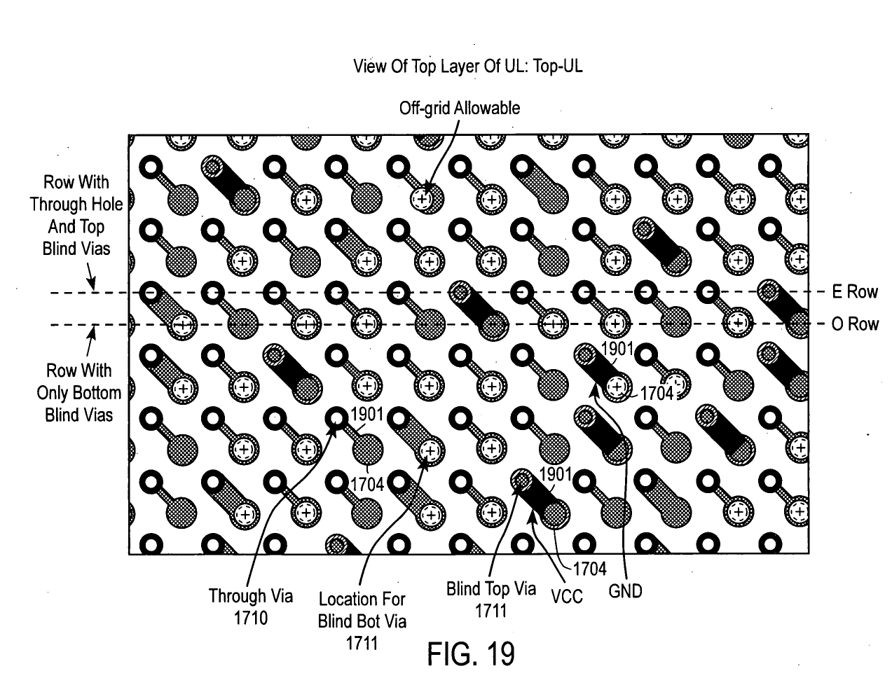

FIG. 14 is a side view of a second embodiment of a circuit card of the processor system of FIG. 3. FIG. 15 is a top plan view of the circuit card of FIG. 14. FIG. 16 is a bottom plan view of the circuit card of FIG. 14. Only four memory devices 121 are labeled for simplicity and clarity. Although memory 121 and processor 810 are shown, the memory 122 and the processor 820 may be similarly disposed on the circuit board 130. In one embodiment, a plurality of termination resistors 1401 are coupled to contacts (see FIGS. 19-23) on the circuit board. The termination resistors 1401 are disposed on the side of the circuit board 130 opposite that of the processors 810 and 820 and memory devices 121 and 122 to provide series termination at close proximity to the source or load (or both) of various signals. In one embodiment, the termination resistors 1401 are of type 0201 size (e.g., have dimensions of approximately 0.02″ ×0.01″) or smaller as defined by the JEDEC standard for SMD (surface mount devices).

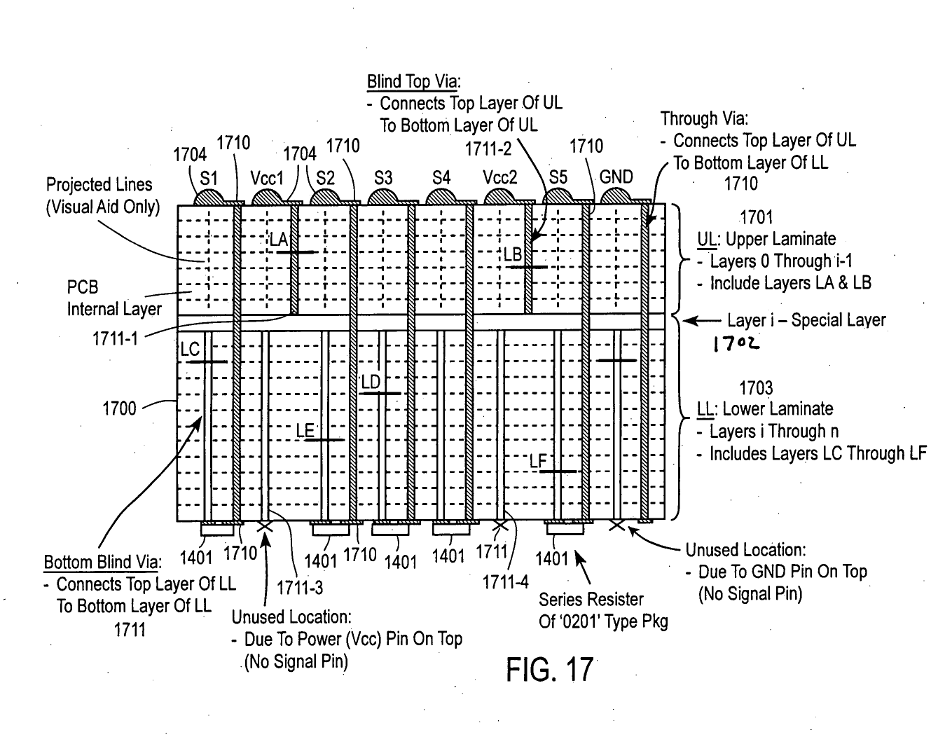

FIG. 17 is a cross-sectional view of a third embodiment of a circuit card 1700. The circuit board 1700 may be used for the circuit board 130 described above. The circuit board 1700 comprises an upper laminate 1701, an intermediate layer 1702, and a lower laminate 1703. The upper laminate 1701 and the lower laminate 1703 each comprise a plurality of layers with circuit traces or interconnection lines, power lines or ground lines. Each layer typically comprises an insulator substrate with electrical interconnection lines on a surface, and holes filled with electrical conductors. Electrical contacts 1704 are disposed on the top surface of the upper laminate 1701 and the bottom surface of the lower laminate 1703. Through vias 1710 are disposed in holes through the upper laminate 1701, the intermediate layer 1702, and the lower laminate 1703 between electrical contacts 1704 on the upper laminate 1701 and the lower laminate 1703. Termination resistors 1401 coupled to some of the electrical contacts 1704 and between the through holes 1710. Blind vias 1711 or buried vias (not shown) may be disposed in holes in the upper laminate 1701 and the lower laminate 1703. Blind vias 1711 do not extend into the other laminate. The blind vias 1711 may be coupled to power contacts of the processor system or for electrical connection between a processor, such as processor 810 or 820, and a memory, such as memory 121 or 122. Blind vias 1711-1 and 1117-2 in the upper laminate 1701 also form a shorter stub than the through hole vias 1710. By using these blind vias 1711-1 and 1711-2 for power terminals, such as VCC1 or VCC2, simultaneous switching output (SSO) effects can be mitigated. Blind vias 1711 in the lower laminate 1703 are used to complete the signal that goes through the series termination resistors 1401. Some blind vias 1711, such as 1711-3 and 1711-4, in the lower laminate 1703 do not connect to series termination resistors 1401 because they may be below or above an electrical contact 1704 that is used for power, such as VCC1 and VCC2, or ground GND, in the other laminate, in which case there is no signal to connect to. These blind vias 1711 are shown with an ‘X’ on one end of the via. Because they are unused, they can be omitted from the final artwork.

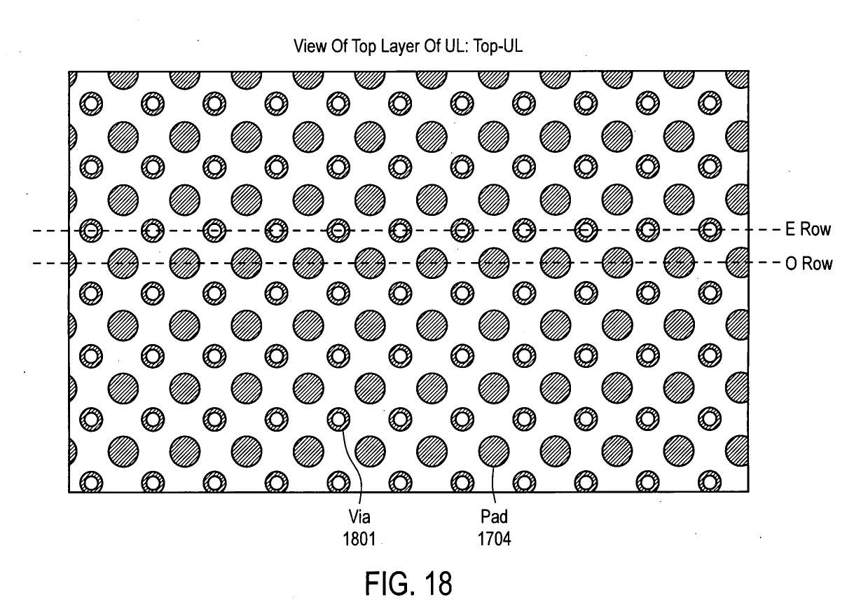

FIG. 18 is a top plan view of a portion of the circuit card 1700. The top surface of the upper laminate 1701 is shown with vias 1801 and pads 1704. The vias 1801 may correspond to through vias 1710 and blind vias 1711.

FIG. 19 is a top plan view of a portion of the circuit card 1700. An electrical trace 1901 couples an electrical contact 1704 to a through via 1710 or a blind via 1711. Some electrical contacts 1704 are above blind vias 1711 in the lower laminate 1703 and are indicated by a cross hair in a circle of the contact 1704. The contact 1704 may be offset from the blind vias in the lower laminate 1703. Power VCC and ground GND may have wider electrical traces 1901.

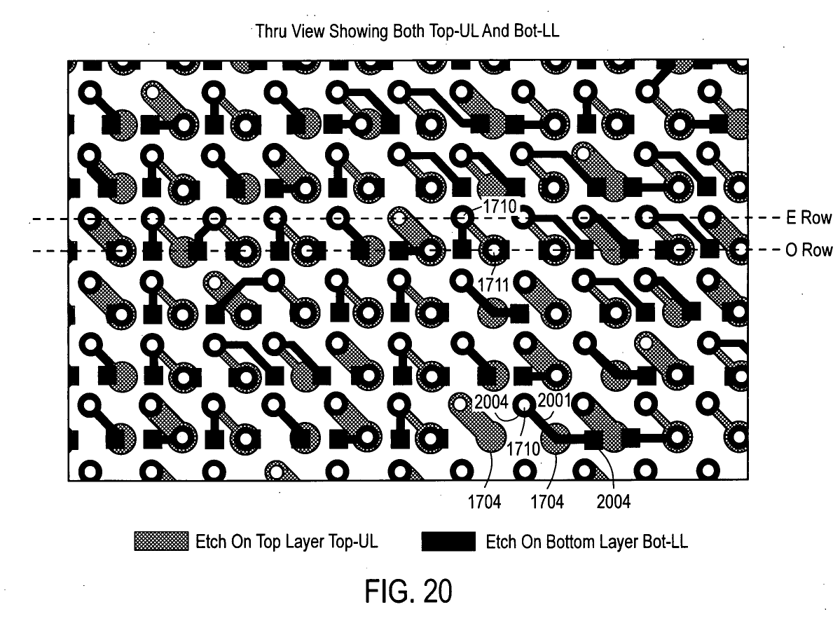

FIG. 20 is a top plan view of a portion of the circuit card 1700 and showing projections of electrical traces 2001 and electrical contacts 2004 on the bottom surface of the lower laminate 1703 on the top surface of the upper laminate 1701. Electrical contacts 2004 that are shown as circles form the bottom side of the through hole via 1710 which connects the top layer to the bottom layer or via 1711 which connects the bottom layer to the inner layers in the lower laminate 1703. It can be noted that the power terminals 1704 on the top layer, distinguishable by their wider connection to the via, are connected to blind vias 1711 which do not protrude in the bottom layer and do thus not have a corresponding circle. Electrical contacts 2004 on the bottom surface are that are shown as squares instead of circles form the contact pads for the surface mounted type 0201 resistors. Note that the contact pad may overlap with a via underneath it, which in this case is a blind via 1711, known as via-in-pad technology. Further, it can be distinguished that through hole vias 1710 are aligned in one row, labeled Erow and blind vias 1711 are aligned in another row, labeled Orow. (For simplicity only one row is labeled Erow—even row—and one row is labeled Orow—odd row.). This alignment is not a requirement, different patterns exist that mix the placement through holes 1710 and blind vias 1711. It should be noted however, that the via underneath the electrical contact 1704 is a blind via 1711 as it would otherwise short out with electrical contact 1704.

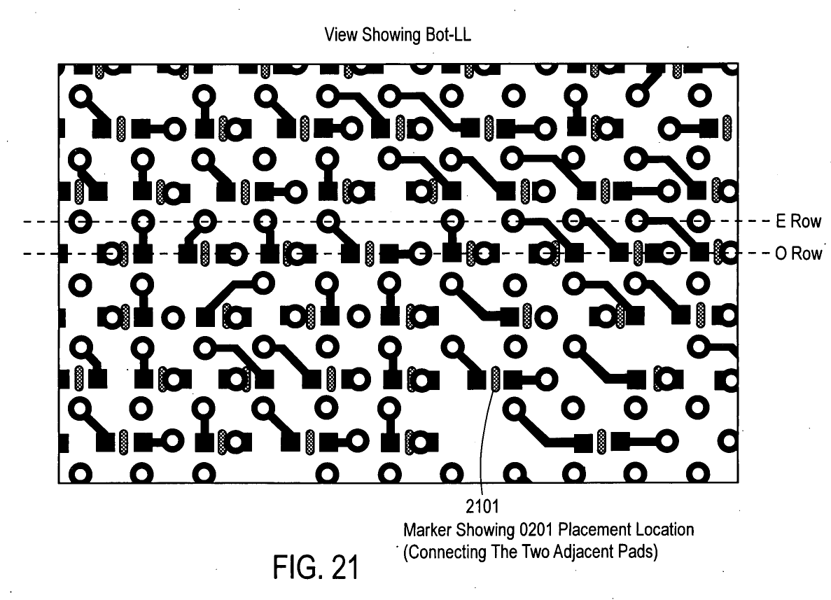

FIG. 21 is a bottom plan view of a portion of the lower laminate 1703 including a marker 2101 which is a guide for placement of the termination resistors 1401. The placement of the resister 2401 should overlap with the guide, e.g., where the guide is shown, the two adjacent pads are connected by a single resistor of type 0201

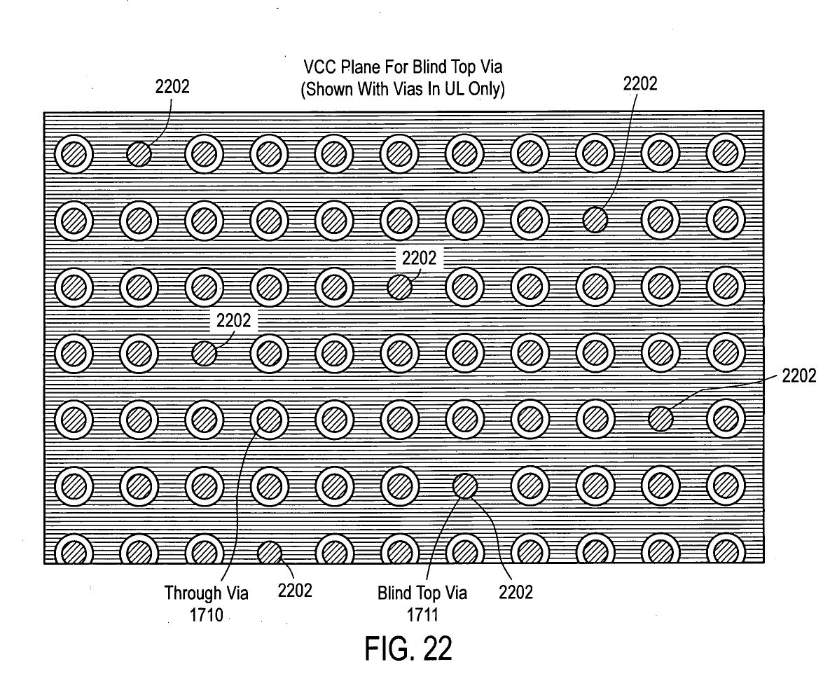

FIG. 22 is a top plan view of a voltage layer of the upper laminate 1701 of the circuit card 1700 and including through vias 1710 and blind vias 1711 in the upper laminate 1701. This voltage plane connects to all the blind vias 1711 that belong to this power plane. This is distinguishable by the vias 1711 (labeled 2202) not having a clearing area, in other words, shorting to the plane. Seven instances of such vias are shown. Notice that these seven vias are placed on the same rows and columns as the through hole vias.

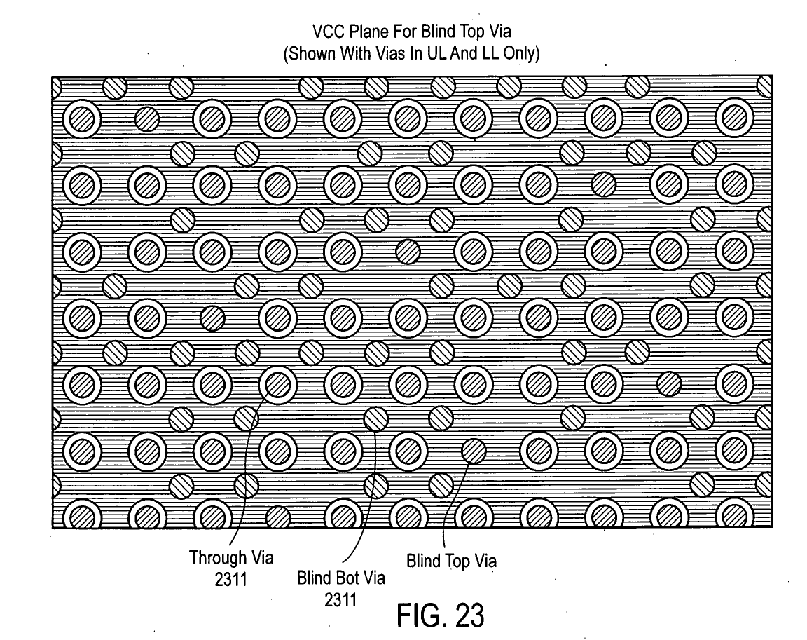

FIG. 23 is the same view as FIG. 22, with as an added detail it also shows the blind vias 1711 in the lower laminate 1703. Aside from the seven instances of 1711 vias in the upper laminate 1701, all vias that do not have a clearing around them are blind vias 1711 in lower laminate 1703 and are marked as 2311. They cannot short to the voltage plane, as the voltage plane is located in the upper laminate. Notice that the blind vias 1711 in the lower laminate 1703 are placed in between the rows and columns that are formed by the through hole vias 1710, which have the clearing.

The thus illustrated patterns depict how series termination can be achieved at very close proximity to the source or load signals. The patterns are for illustration only, and are not limited to the scope of the invention.

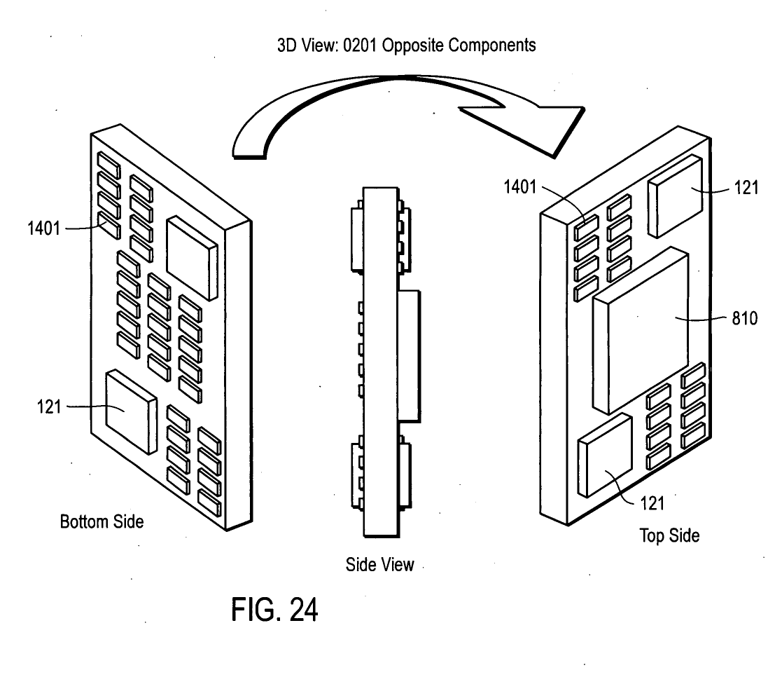

FIG. 24 illustrates bottom and top perspective views and a side view of the circuit board of FIG. 14 with termination resistors 1401. The plurality of discrete passive termination resistors 1401 are disposed between the data interface contacts 1704 that connect to the processor or memory components at the opposite side of the circuit board 1700.

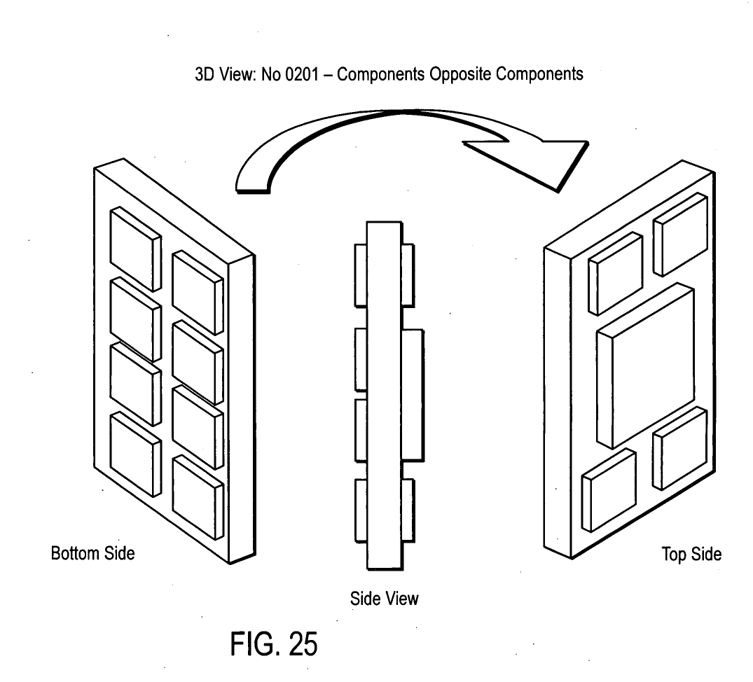

FIG. 25 illustrates bottom and top perspective views and a side view of another embodiment of the circuit board 130 in which case the components are placed on opposite sides and either have no termination resistors 1401 or the termination resistors 1401 are placed between components on the same side. These may comprise circuit boards that utilize the MGT interfacing techniques described earlier, or circuit boards that use active on-die termination which adheres to standards that result in lower power consumption in the interface. Also, for relatively small modules, high switching frequencies are achievable with low power without the termination resistors as the signal path distances are kept very short. In most applications, the modules are too large to make this work reliably, and termination resistors are deployed.

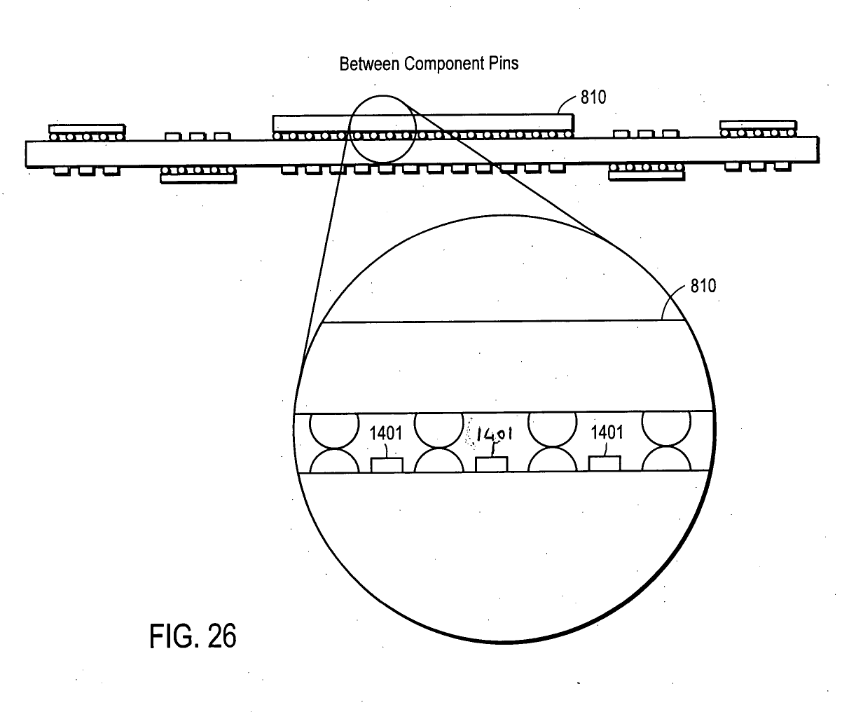

FIG. 26 is an exploded view of the circuit board of FIG. 25 in which termination resistors 1401 are disposed between contacts 1704 underneath the processor 810 (or 820, which is not shown). Accordingly, the termination resistors have dimensions less than the spacing between the contacts 1704. Although the PCB routability of such an approach is greatly simplified, the manufacturability of such an approach is highly complex. The 0201 type resistors are not visible once the components are placed over them, and rework becomes very difficult, as the resistors are not accessible.

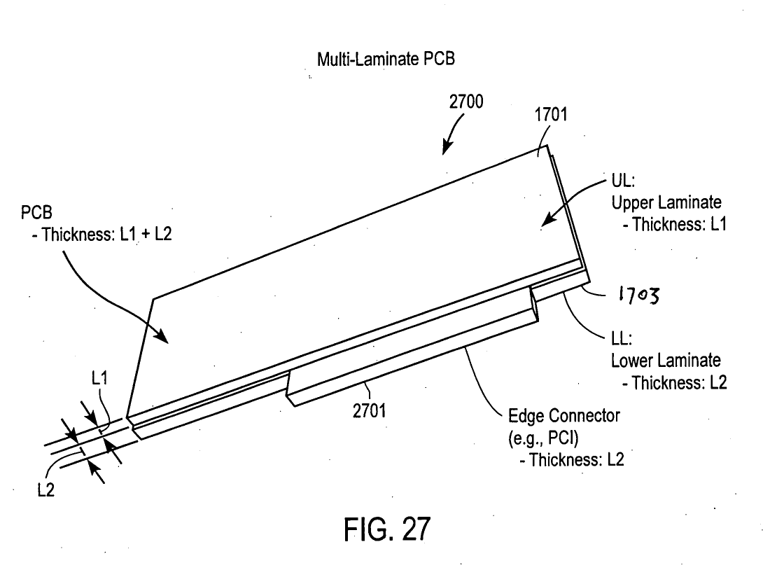

FIG. 27 is a perspective view of a multi-laminate circuit board 2700. The circuit board 2700 includes an upper laminate 1701 having a thickness L1 and a lower laminate 1703 having a thickness L2 for a total board thickness of L1+L2 (the intermediate layer 1702 is presumed to have a negligible thickness for simplicity, but its thickness may be included.) The circuit board 2700 further comprises an edge connector 2701 having a thickness L2. In an illustrative embodiment, the edge connector 2701 complies with a PCI standard. In one embodiment, the circuit board 2700 has a thickness greater than 65 mil.

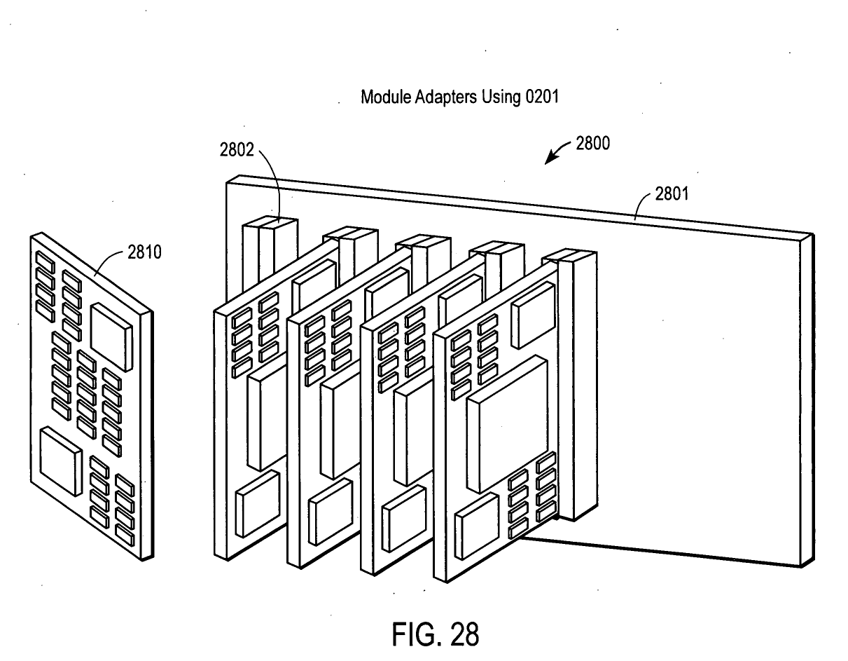

FIG. 28 is a perspective view of a processor system 2800 that includes a circuit board 2801 with a plurality of connectors 2802 and a plurality of processor modules 2810 coupled to or plugged in the connectors 2802. The processor module 2810 may be the processor module of FIG. 24. The circuit board 2801 may include a controller (not shown), e.g. a PCI controller, for transport methods between the modules 2810 that are active. For circuit boards 2801 that do not include a controller, the transport methods are passive.

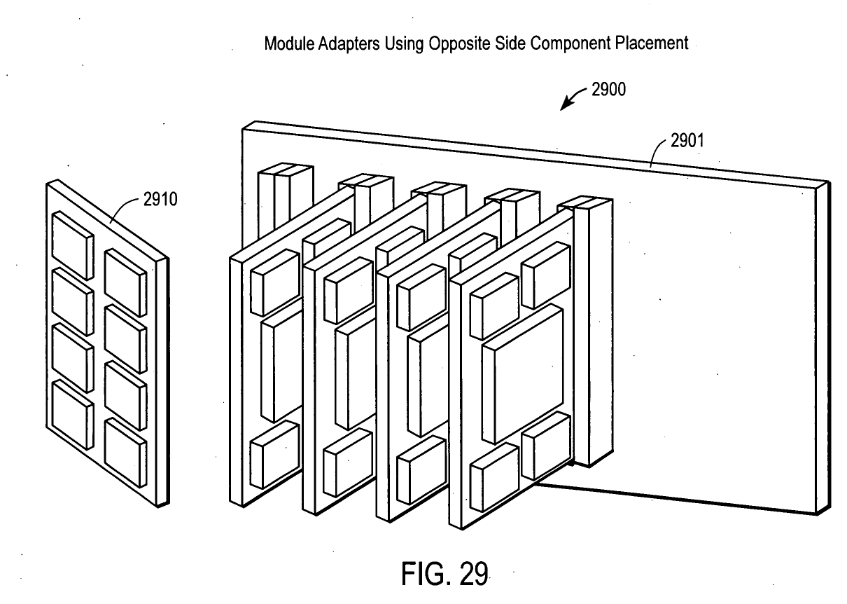

FIG. 29 is a perspective view of a processor system 2900 that includes a circuit board 2801 with a plurality of connectors 2802 and a plurality of processor modules 2910 coupled to or plugged in the connectors 2802. The processor module 2910 may be the processor module of FIG. 25.

### Other Alternative Embodiments

In an alternative embodiment, the circuit board does not include discrete passive termination. Examples of such circuit boards include the processor module of FIG. 25. Other examples may be circuit boards that utilize the MGT interfacing techniques described earlier, or circuit boards that use active on-die termination which adheres to standards that result in lower power consumption in the interface.

In one embodiment, the processor 810 is realized with more than 1,500 I/0 pins. The I/0 pins include power and ground pins. In this embodiment, the power and ground pins comprise less than 35% of the total available I/0 pins, and of the remaining 65% of the I/0 pins more than 85% is dedicated to interfacing to the memory 121 (data, address & control). In this embodiment, the processor 810 uses less than 4 Watts to operate the interface to memory 121, while realizing a memory 121 interface bandwidth interface above 200 billion bits per second. In contrast, an MGT based interface realizing similar bandwidth consumes about 20 W.

The processor systems described herein may use natural convection cooling to operate in a room temperature environment. By not using fans, heat sinks, or other cooling, the processor systems may be implemented in smaller volumes even with the high data transfers or large memory sizes. The processor device may dissipate heat at a rate such that the number of bits of data per second per watt dissipated is greater than 50 billion bits per second per watt in our preferred embodiment. In an alternative MGT based embodiment this number may be greater than 10 billion bits per second per watt.

The processors described herein may be implemented in a plurality of processor components.

In one embodiment, the processors described herein use the simultaneous switching output (SSO) interface, described in FIG. 17, using shortened pin stubs by using blind vias 1711. The data signals switch simultaneously. The blind vias 1711 of the power lines reduce stub length by extending only within the upper layer. This allows more pins to be disposed in an area. The reduced pin stubs interface reduces SSO effects. In another embodiment, all data signals do not switch simultaneously.

Advantages of the present invention include a processor having a high data rate transfer to a large capacity memory in a small package implemented in a circuit board designed for manufacturing.

Upon reading this disclosure, those of skill in the art will appreciate still additional alternative structural and functional designs for a processor system through the disclosed principles herein. For example, the VLIW processor architecture presented here can also be used for other applications. For example, the processor architecture can be extended from single bit, 2-state, logic simulation to 2 bit, 4-state logic simulation, to fixed width computing (e.g., DSP programming), and to floating point computing (e.g. IEEE-754). Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A hardware accelerator for performing acceleration of program execution, the hardware accelerator comprising:
a parallel processor comprising a plurality of processor units communicatively coupled to each other, wherein each of the processor units is configurable to execute a logic function; and
an external program memory communicatively coupled to the parallel processor for storing instructions for the processor units, wherein instructions are transferable from the program memory to the parallel processor at an average rate of at least 200 billion bits per second while related input/output activity of the parallel processor to the program memory consumes an average power less than five Watts and related input/output activity of the program memory to the parallel processor consumes an average power less than five Watts.

2. The hardware accelerator of claim 1, wherein the hardware accelerator consumes total average power less than 50 Watts.

3. The hardware accelerator of claim 1, wherein the program memory has capacity to store instructions having least 20 billion bits.

4. The hardware accelerator of claim 1, wherein the program memory has capacity to store data having at least 20 billion bits.

5. A hardware accelerator for executing very long instruction words, the hardware accelerator comprising:
a very long instruction word (VLIW) processor comprising a plurality of processor units communicatively coupled to each other, wherein each of the processor units is configurable to execute a logic function, the VLIW processor further including at least 500 interface pins; and
an external program memory communicatively coupled to the VLIW processor via the pins, for storing instructions for the processor units, wherein instructions are transferable from the program memory to the VLIW processor at an average rate of at least 200 billion bits per second while related input/output activity of the VLIW processor to the program memory consumes an average power less than five Watts and related input/output activity of the program memory to the VLIW processor consumes an average power less than five Watts.

6. The hardware accelerator of claim 5, wherein the hardware accelerator consumes total average power less than 50 Watts.

7. The hardware accelerator of claim 5, wherein the program memory has capacity to store instructions having least 20 billion bits.

8. The hardware accelerator of claim 5, wherein the program memory has capacity to store data having at least 20 billion bits.

9. A hardware accelerator for performing logic simulation of a logic design, the hardware accelerator comprising:
a simulation processor comprising a plurality of processor units communicatively coupled to each other, wherein each of the processor units is configurable to simulate a logic function; and
an external program memory communicatively coupled to the simulation processor for storing instructions for the processor units, wherein instructions are transferable from the program memory to the simulation processor at an average rate of at least 200 billion bits per second while related input/output activity of the simulation processor to the program memory consumes an average power less than five Watts and related input/output activity of the program memory to the simulation processor consumes an average power less than five Watts.

10. The hardware accelerator of claim 9, wherein the hardware accelerator consumes total average power less than 50 Watts.

11. The hardware accelerator of claim 9, wherein the program memory has capacity to store instructions having least 20 billion bits.

12. The hardware accelerator of claim 9, wherein the program memory has capacity to store data having at least 20 billion bits.

13. A hardware accelerator for executing very long instruction words of a logic design, the hardware accelerator comprising:
a very long instruction word (VLIW) processor comprising a plurality of processor units communicatively coupled to each other, wherein each of the processor units is configurable to simulate a logic function, the VLIW processor further including at least 500 interface pins; and
an external program memory communicatively coupled to the VLIW processor via the pins, for storing instructions for the processor units, wherein instructions are transferable from the program memory to the VLIW processor at an average rate of at least 200 billion bits per second while related input/output activity of the VLIW processor to the program memory consumes an average power less than five Watts and related input/output activity of the program memory to the VLIW processor consumes an average power less than five Watts.

14. The hardware accelerator of claim 13, wherein the hardware accelerator consumes total average power less than 50 Watts.

15. The hardware accelerator of claim 13, wherein the program memory has capacity to store instructions having least 20 billion bits.

16. The hardware accelerator of claim 13, wherein the program memory has capacity to store data having at least 20 billion bits.

17. A circuit board comprising:
an insulator substrate;
a first mounting region disposed on the insulator substrate for coupling to a first processor device, the first mounting region including a plurality of first contacts for coupling to corresponding ones of a plurality of electrical contacts of the first processor device;
a second mounting region disposed on the insulator substrate for coupling to a memory device, the second mounting region including a plurality of second contacts for coupling to corresponding ones of a plurality of electrical contacts of the memory device; and
a plurality of interconnection lines disposed on the insulator substrate coupled between said first and second contacts to communicate signals between said first and second contacts;
wherein the first and second contacts are disposed for communicating at least 200 billion bits of data per second between the first processor device and the memory device while related input/output activity of the first processor device to the memory device consumes an average power less than five Watts and related input/output activity of the memory device to the first processor device consumes an average power less than five Watts.

18. The circuit board of claim 17 further comprising:
a third mounting region disposed on the insulator substrate for coupling to a connector for communicating to an external device, the third mounting region including a plurality of third contacts for coupling to corresponding ones of a plurality of electrical contacts of the connector,
wherein the plurality of interconnection lines further couple some of the third contacts to some of the first or second contacts.

19. The circuit board of claim 17 further comprising a fourth mounting region disposed on a side of the insulator substrate opposite a side of the insulator substrate whereon said first mounting region is disposed, said fourth mounting region including a plurality of fourth contacts for coupling to corresponding ones of a plurality of termination resistors.

20. The circuit board of claim 19 wherein the termination resistors have dimensions less than spacing between the first contacts.

21. The circuit board of claim 19 wherein the insulator substrate comprises a plurality of insulator layers and a plurality of vias between ones of said plurality of insulator layers that are not on a top surface or a bottom surface of said insulator substrate.

22. The circuit board of claim 17 wherein the processor executes a simulation engine.

23. The circuit board of claim 17 further comprising:
a third mounting region disposed on the insulator substrate for coupling to a second processor device, the first mounting region including a plurality of third contacts for coupling to corresponding ones of a plurality of electrical contacts of the second processor device,
wherein the plurality of interconnection lines further couple some of the third contacts to some of the first or second contacts,
wherein the first and third contacts being disposed for communicating at least 200 billion bits of data per second between the first processor device and the second processor device.

24. A processor system comprising:
a first processor device including a plurality of first electrical contacts for communicating signals;
a memory device including a plurality of second electrical contacts for communicating signals;
a circuit board comprising an insulator substrate including a plurality of third electrical contacts coupled to the first electrical contacts of the first processor device, including a plurality of fourth electrical contacts coupled to the second electrical contacts of the memory device, and including a plurality of interconnection lines coupled between said third and fourth electrical contacts to communicate said signals between said first and second electrical contacts at least 200 billion bits of data per second between the first processor device and the memory device while related input/output activity of the first processor device to the memory device consumes an average power less than five Watts and related input/output activity of the memory device to the first processor device consumes an average power less than five Watts.

25. The processor system of claim 24 further comprising:
the circuit board further comprising a plurality of fifth electrical contacts and a connector coupled to the fifth electrical contacts and for coupling to an external device,
wherein the plurality of interconnection lines further couple some of the fifth electrical contacts to first processor device and the memory device.

26. The processor system of claim 25 wherein the connector complies with a PCI standard.

27. The processor system of claim 24 wherein the circuit board further comprises a plurality of termination resistors on a side of the insulation substrate opposite the first processor device and the memory device.

28. The processor system of claim 27 wherein the insulator substrate comprises a plurality of insulator layers and a plurality of vias between ones of said plurality of insulator layers that are not on a top surface or a bottom surface of said insulator substrate.

29. The processor system of claim 24 wherein the first processor device executes a simulation engine.

30. The processor system of claim 24 further comprising:
a second processor device including a plurality of fifth electrical contacts,
wherein the insulator substrate includes a plurality of sixth electrical contacts coupled to the fifth electrical contacts of the second processor device,
wherein the plurality of interconnection lines further couple some of the sixth electrical contacts to some of the third or fourth electrical contacts,
wherein the third, fourth and sixth electrical contacts being disposed for communicating at least five billion bits of data per second between the first processor device and the second processor device.

31. The processor system of claim 24 wherein the processor uses natural convection cooling to operate in a room temperature environment.

32. The processor system of claim 31 wherein the first processor device dissipates heat at a rate such that the number of bits of data per second per watt dissipated is greater than 50 billion bits per second per watt.

33. The processor system of claim 31 wherein the first processor device dissipates heat at a rate such that the number of bits of data per second per watt dissipated is greater than 10 billion bits per second per watt.

34. The processor system of claim 24 wherein the processor uses active cooling solutions to operate in a room temperature environment.

35. The processor system of claim 34 wherein the first processor device dissipates heat at a rate such that the number of bits of data per second per watt dissipated is greater than 50 billion bits per second per watt.

36. The processor system of claim 34 wherein the first processor device dissipates heat at a rate such that the number of bits of data per second per watt dissipated is greater than 10 billion bits per second per watt.

37. A processor system comprising:
a first processor device including a plurality of first electrical contacts for communicating signals;
a second processor device including a plurality of second electrical contacts for communicating signals;
a first memory device system coupled to the first processor device, including a plurality of third electrical contacts for communicating signals and including a first plurality of memory devices arranged for shallow memory addressing;
a second memory device system coupled to the second processor device, including a plurality of fourth electrical contacts for communicating signals and including a second plurality of memory devices arranged for deep memory addressing;
a circuit board comprising a plurality of fifth electrical contacts coupled to the first, second, third and fourth electrical contacts to communicate said signals between the first and processor devices and the first and second memory device systems at least five billion bits of data per second while related input/output activity of the first and second processor devices to the first and second memory device systems consumes an average power less than five Watts and related input/output activity of the first and second memory device systems to the first and second processor devices consumes an average power less than five Watts.

38. A processor system comprising:
a first processor device including an input/output interface having a plurality of first data interface contacts for communicating signals, the input/output interface consuming no standby current;
a memory system including an input/output interface having a plurality of second data interface contacts, the input/output interface consuming no standby current, each of the first and second data interface contacts communicating signals at data transport rate of at least 300 MHz;
a circuit board comprising an insulator substrate including a plurality of third data interface contacts coupled to the first data interface contacts of the first processor device, including a plurality of fourth data interface contacts coupled to the second data interface contacts of the memory system, and including a plurality of interconnection lines coupled between said third and fourth data interface contacts to communicate said signals at a rate of at least 200 billion bits of data per second between the first processor device and the memory system while the input/output interfaces of the first processor device to the memory system consume an average power less than five Watts during said data transport to the memory system and related input/output activity of the memory device to the first processor device consumes an average power less than five Watts during said data transport to the first processor device.

39. The processor system of claim 38 wherein the circuit board includes discrete passive termination resistors on interconnection lines coupled to said third and fourth data interface contacts.

40. The processor system of claim 39 wherein the discrete passive termination resistors are realized as type “0201” or smaller.

41. The processor system of claim 40 wherein the discrete passive termination resistors are disposed on a side of the circuit board opposite a side of the circuit board on which the processor device and the memory system are disposed and opposite the first processor device and the memory system.

42. The processor system of claim 40 wherein the discrete passive termination resistors are disposed between the first and second data interface contacts.

43. The processor system of claim 40 wherein the discrete passive termination resistors are disposed between data interface contacts coupled to the first processor device and the memory system on a side of the circuit board opposite processor to the first processor device and the memory system.

44. The processor system of claim 40 further comprising at least one adapter card plugged into the circuit board, the memory system comprises a plurality of memory devices disposed on said at least one adapter card comprising the memory components are placed on adapter cards that are plugged into the circuit board, the discrete passive termination resistors being disposed between the data interface contacts that connect to the processor or memory components at the opposite side of the PCB.

45. The processor system of claim 38 wherein the interconnection lines for communicating said signals do not include discrete passive termination.

46. The processor system of claim 45 wherein the memory system is disposed on a side of the circuit board opposite a side on which the first processor device is disposed.

47. The processor system of claim 45 further comprising at least one adapter card plugged into the circuit board, the memory system comprises a plurality of memory devices disposed on said at least one adapter card comprising the memory components are placed on adapter cards that are plugged into the circuit board.

48. The processor of claim 45 wherein the circuit board further comprises a substrate and a module coupled to the substrate, the first processor device and the memory system being disposed on the module.

49. The processor system of claim 38 wherein the number of first data interface contacts is greater than 1,000.

50. The processor system of claim 49 wherein the first processor device further includes power interface contacts for power and ground signals, the number of power interface contacts being less than 35% of the sum of the number of power interface contacts and the first data interface contacts.

51. The processor system of claim 49 and the total number of pins on the processor package dedicated to memory for address, data and control) is more than 85% of the number of package pins of the processor component excluding the power and ground pins of the processor component.

52. The processor system of claim 49 wherein the first processor device further includes power interface contacts for power and ground signals, the number of first data interface contacts being greater than the number of power interface contacts.

53. The processor system of claim 38 wherein the first processor includes an MGT interface and the number of first data interface contacts is realized using the MGT interface.

54. The processor system of claim 38 wherein the data signals switch simultaneously.

55. The processor system of claim 54 wherein the circuit board has a thickness greater than 65 mil.

56. The processor system of claim 55 wherein the circuit board is processed as two laminates in which power pin stubs protrude to only one of the laminates.

57. The processor system of claim 38 wherein all data signals do not switch simultaneously.

58. The processor system of claim 38 wherein some of the interconnections between the first processor device and memory system include through holes in the circuit board between both sides of the circuit board.

59. The processor system of claim 58 wherein the circuit board is constructed as a multi-laminate.

60. The processor system of claim 59 wherein at least one of the laminates includes blind vias for the electrical connection between the first processor device and the memory device.

61. The processor system of claim 59 and at least one or more of the power contacts for the processor system connect to blind vias.

62. The processor system of claim 58 and the discrete passive discrete termination is disposed between the through holes.

63. The processor system of claim 38 further including a standard interfacing connection to a host computer.

64. The processor system of claim 63 further comprising a connector on an edge of the circuit board for proving the standard interfacing, the circuit board having an overall thickness greater than a maximum thickness of edge connector, the circuit board having a second thickness on the edge at the location of the connector such that the sum of the second thickness and a thickness of the connector is less than the maximum thickness.

65. The processor system of claim 63 wherein the system complies to a standard mechanical interfacing specification.

66. The processor system of claim 63 wherein the system complies to a standard mechanical interfacing specification.

67. The processor system of claim 66 further comprising a connector coupled to the circuit board, wherein the system has physical dimensions complying with a PCI standard.

68. The processor system of claim 66 wherein the system is compliant with a mechanical chassis standard which restricts power consumption and heat generation.

69. The processor system of claim 63 wherein the interface standard allows direct memory access (DMA) to the memory system from the host computer.

70. The processor system of claim 63 wherein the memory system is subdivided into at least two different groups, each group including one or more memory components and each group having a separate DMA access from a host computer.

71. The processor system of claim 63 wherein one memory group is used for instruction memory and one memory group is used for data memory.

72. The processor system of claim 71 wherein the system allows parallel update for the memory group used for data memory (from the host computer using DMA) while the system is processing data using the memory group used for instruction memory.

73. The processor system of claim 71 wherein each memory groups is at least 2 Gigabytes in size.

74. The processor system of claim 71 wherein the first processor system includes a plurality of processor components

75. The processor system of claim 38 wherein said circuit board has a connector to enable data transport to another circuit board.

76. A processor system comprising:
a first circuit card having means of connecting to a first processor system comprising:
a first processor device including an input/output interface having a plurality of first data interface contacts for communicating signals, the input/output interface consuming no standby current;
a first memory system including an input/output interface having a plurality of second data interface contacts, the input/output interface consuming no standby current, each of the first and second data interface contacts communicating signals at data transport rate of at least 300 MHz;
a first circuit board comprising an insulator substrate including a plurality of third data interface contacts coupled to the first data interface contacts of the first processor device, including a plurality of fourth data interface contacts coupled to the second data interface contacts of the memory system, and including a plurality of interconnection lines coupled between said third and fourth data interface contacts to communicate said signals at a rate of at least 200 billion bits of data per second between the first processor device and the memory system while the input/output interfaces of the first processor device to the memory system consume an average power less than five Watts during said data transport to the memory system and related input/output activity of the memory device to the first processor device consumes an average power less than five Watts during said data transport to the first processor device;
said first circuit card having means of connecting to a second processor system comprising:
a second processor device including an input/output interface having a plurality of fifth data interface contacts for communicating signals, the input/output interface consuming no standby current;
a second memory system including an input/output interface having a plurality of sixth data interface contacts, the input/output interface consuming no standby current, each of the third and fourth data interface contacts communicating signals at data transport rate of at least 300 MHz;
a second circuit board comprising an insulator substrate including a plurality of seventh data interface contacts coupled to the fifth data interface contacts of the first processor device, including a plurality of eighth data interface contacts coupled to the sixth data interface contacts of the memory system, and including a plurality of interconnection lines coupled between said seventh and eighth data interface contacts to communicate said signals at a rate of at least 200 billion bits of data per second between the second processor device and the second memory system while the input/output interfaces of the second processor device to the second memory system consume an average power less than five Watts during said data transport to the second memory system and related input/output activity of the second memory system to the second processor device consumes an average power less than five Watts during said data transport to the first processor device,
said first circuit card having means of transporting signals from the first processor system to the second processor system.

77. The processor system of claim 76 wherein the transport method is passive.

78. The processor system of claim 76 wherein the transport method is active.

79. The processor system of claim 76 wherein another processor on the first circuit card communicates the data signals to and from both first and second processor system.

80. The processor system of claim 76 further including a standard interfacing connection to a host computer.

81. The processor system of claim 80 wherein the interface standard allows direct memory access (DMA) to the memory system from the host computer.

82. The processor system of claim 81 wherein each of the connectors to first and second processor systems allows direct memory access (DMA) to the memory system from the host computer.

83. The processor system of claim 76 wherein the memory system is subdivided into at least two different groups, each group including one or more memory components and each group having a separate DMA access from a host computer.

84. The processor system of claim 76 wherein one memory group is used for instruction memory and one memory group is used for data memory.

85. The processor system of claim 84 wherein the system allows parallel update for the memory group used for data memory (from the host computer using DMA) while the system is processing data using the memory group used for instruction memory.

86. The processor system of claim 84 wherein each memory groups is at least 2 Gigabytes in size.

87. The processor system of claim 84 wherein the first processor system includes a plurality of processor components

88. A processor system comprising:
a first processor device including a plurality of first memory controllers and including an interface circuit;
a second processor device including a plurality of second memory controllers and including an interface circuit;
a first memory device system including a plurality of memories, each memory being coupled to a corresponding first memory controller;
a second memory device system including a plurality of memories, each memory being coupled to a corresponding second memory controller; and
a communication channel coupled to the interface circuits to communicate said signals between the first and processor devices and the first and second memory device systems at least five billion bits of data per second while related input/output activity of the first and second processor devices to the first and second memory device systems consumes an average power less than five Watts and related input/output activity of the first and second memory device systems to the first and second processor devices consumes an average power less than five Watts.
